(19) United States
(12) Patent Application Publication
(10) Pub. No.: US 2009/0094384 A1
(43) Pub. Date: Apr. 9, 2009

(54) Portable computer system for expanding usage function

(76) Inventors: Yi-Wei Tao, Taipei Hsien (TW); An Chung Hsieh, Taipei Hsien (TW); Yi-Lang Chi, Taipei Hsien (TW); Ming-Jen Huang, Taipei Hsien (TW); Shin-Ning Shih, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/153,698

(22) Filed: May 23, 2008

(30) Foreign Application Priority Data
Oct. 5, 2007 (TW) 96137492

(51) Int. Cl. G06F 3/00

(52) U.S. Cl. 710/2

(57) ABSTRACT

A portable computer system for expanding usage function includes an independent host unit and a function expansion unit. The host unit at least includes a motherboard module, a first power supply module, a display module, a wireless transmission module, and a first I/O interface module. The motherboard module, the first power supply module, the display module, the wireless transmission module and the first I/O interface module are electrically connected with the motherboard module. In addition, the display module has a built-in touch pad. The function expansion unit at least includes a keyboard module and a bracket module. The keyboard module is electrically connected with the motherboard module of the host unit. The bracket module is pivoted on the keyboard module, and the bracket module is detachably and electrically connected with the host unit.

### BACKGROUND OF THE INVENTION

1. Field of the Invention

The present invention relates to a portable computer system, and particularly relates to a portable computer system for expanding usage function.

2. Description of the Related Art

According to the development of technology and market requirements, many producers strive to design portable computers (or portable information processing products) that are smaller and lighter and can be carried more easily than the notebook computer of the present art.

However, when the electronic product becomes light and small, some problems can ensue. For example, it is inconvenient for a user to key in data using a small keyboard, and the data input speed of the user may be decreased. If the user uses a touch screen with full screen size without using any keyboard, the product can become still lighter and smaller. However, the input speed when using a touch screen to key in data is even slower than when using a small keyboard. Therefore, it is an important challenge for designers to design an electronic product that has small size and light weight and is easy for the user to operate.

### SUMMARY OF THE INVENTION

One particular aspect of the present invention is to provide a portable computer system for expanding usage function. The portable computer system is divided into two parts that includes an independent host unit and a function expansion unit. The key feature of the present invention is that: some base computer functions such as a display with a touch pad, a battery, a wireless network and some base I/O interfaces etc. are disposed in the host unit, some secondary or expansion computer functions such as a keyboard, an antenna, wire connector and other expansion I/O interfaces are disposed in the function expansion unit. On the other hand, the function expansion unit can be a custom-made product according to user's requirements. For example, if the function expansion unit needs to comprise a strong multimedia function and a strong key-in function, the function expansion unit needs to contain a loudspeaker and a large keyboard.

In order to achieve the above-mentioned aspects, the present invention provides a portable computer system for expanding usage function, including an independent host unit and a function expansion unit.

The host unit at least includes a motherboard module, a first power supply module, a display module, a wireless transmission module, and a first I/O interface module.

The motherboard module, the first power supply module, the display module, the wireless transmission module and the first I/O interface module are electrically connected with the motherboard module. In addition, the display module has a built-in touch pad.

The function expansion unit at least includes a keyboard module and a bracket module. The keyboard module is electrically connected with the motherboard module of the host unit. The bracket module is pivoted on the keyboard module, and the bracket module is detachably and electrically connected with the host unit.

Therefore, on one hand the size and the weight of the host unit can be decreased, on the other hand the user can use complete computer function by electrically matching the host unit and the function expansion unit. Hence, some expansion devices such as keyboard can be disposed in the function expansion unit in order to operate the portable computer system easily for the user. Moreover, on one hand different consumers can establish own standards according to selective function expansion unit, on the other hand the consumer can only select the host unit with some base computer functions due to low cost or select the combination of the host unit and the function expansion unit with extra computer functions due to allowable cost.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1A is one perspective, schematic view of a host unit according to the first embodiment of the present invention;

FIG. 1B is another perspective, schematic view of a host unit according to the first embodiment of the present invention;

FIG. 1C is a function block of a host unit according to the first embodiment of the present invention;

FIG. 2 is a perspective, schematic view of a host unit according to the second embodiment of the present invention;

FIG. 3A is a perspective, schematic view of a host unit according to the third embodiment of the present invention;

FIG. 3B is a function block of a host unit according to the third embodiment of the present invention;

FIG. 4A is a perspective, schematic view of a function expansion unit according to the first embodiment of the present invention;

FIG. 4B is a perspective, schematic view of a function expansion unit has been folded up according to the first embodiment of the present invention;

FIG. 5A is one perspective, schematic view of a function expansion unit according to the second embodiment of the present invention;

FIG. 5B is another perspective, schematic view of a function expansion unit according to the second embodiment of the present invention;

FIG. 5C is a perspective, schematic view of a function expansion unit has been folded up according to the second embodiment of the present invention;

FIG. 5D is a function block of a function expansion unit according to the second embodiment of the present invention;

FIG. 6 is a perspective, schematic view of a function expansion unit according to the third embodiment of the present invention;

FIG. 7A is one perspective, schematic view of a function expansion unit according to the fourth embodiment of the present invention;

FIG. 7B is another perspective, schematic view of a function expansion unit according to the fourth embodiment of the present invention;

FIG. 7C is a perspective, schematic view of a function expansion unit has been folded up according to the fourth embodiment of the present invention;

FIG. 7D is a function block of a function expansion unit according to the fourth embodiment of the present invention;

FIG. 8 is a perspective, schematic view of a function expansion unit according to the fifth embodiment of the present invention;

FIG. 9A is a perspective, schematic view of a function expansion unit according to the sixth embodiment of the present invention;

FIG. 9B is a perspective, schematic view of a function expansion unit has been folded up according to the sixth embodiment of the present invention;

FIG. 10A is a perspective, schematic view of a host unit of the second embodiment electrically connected with a function expansion unit of the first embodiment;

FIG. 10B is a perspective, schematic view of a host unit of the second embodiment electrically connected with and folded toward a function expansion unit of the first embodiment;

FIG. 11A is a perspective, schematic view of a host unit of the second embodiment electrically connected with a function expansion unit of the second embodiment;

FIG. 11B is a perspective, schematic view of a host unit of the second embodiment electrically connected with and folded toward a function expansion unit of the second embodiment;

FIG. 12A is a perspective, schematic view of a host unit of the second embodiment electrically connected with a function expansion unit of the fourth embodiment;

FIG. 12B is a perspective, schematic view of a host unit of the second embodiment electrically connected with and folded toward a function expansion unit of the fourth embodiment;

FIG. 12C is a function block of a host unit of the second embodiment electrically connected with a function expansion unit of the fourth embodiment;

FIG. 13A is one perspective, schematic view of a host unit of the second embodiment electrically connected with a function expansion unit of the sixth embodiment;

FIG. 13B is a perspective, schematic view of a host unit of the second embodiment electrically connected with and folded toward a function expansion unit of the sixth embodiment; and

FIG. 13C is another perspective, schematic view of a host unit of the second embodiment electrically connected with a function expansion unit of the sixth embodiment.

### DETAILED DESCRIPTION OF THE PREFERRED EMBODIMENTS

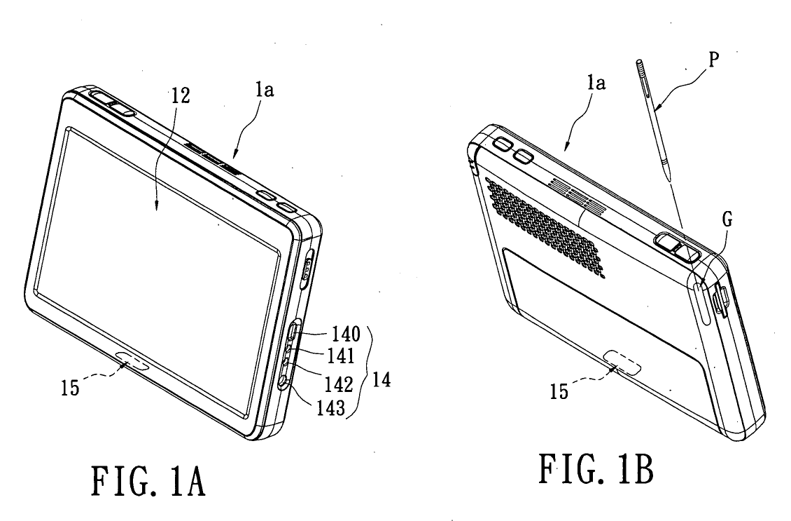

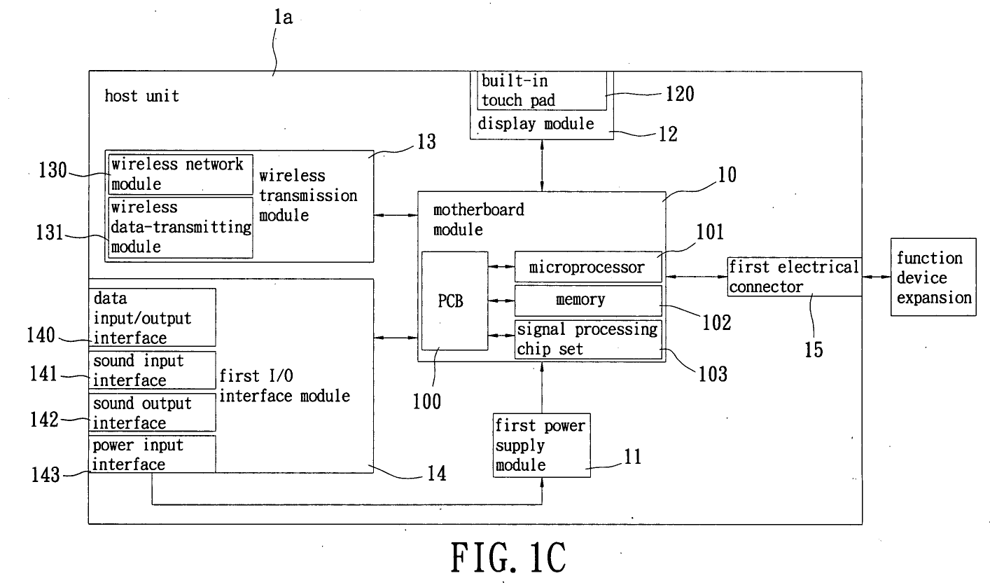

Referring to FIGS. 1A to 1C, FIG. 1A shows one perspective, schematic view of a host unit according to the first embodiment of the present invention, FIG. 1B shows another perspective, schematic view of a host unit according to the first embodiment of the present invention, and FIG. 1C shows a function block of a host unit according to the first embodiment of the present invention.

Referring to above-mentioned figures, the first embodiment of the present invention provides an independent host unit 1a that includes: a motherboard module 10, a first power supply module 11, a display module 12, a wireless transmission module 13, a first I/O interface module 14, and a first electrical connector 15.

The motherboard module 10 is received in the host unit 1a, and the motherboard module 10 at least includes a PCB 100, and a microprocessor 101, a memory 102 and a signal processing chip set 103 electrically connected with the PCB 100. In addition, the microprocessor 101 is used to process data and programs. The memory 102 is used to store data and programs. The signal processing chip set 103 is used to communicate the microprocessor 101 with computer periphery devices (not shown) of the host 1a.

The first power supply module 11 is received in the host unit 1a and electrically connected with the motherboard module 10 for supplying power to the host unit 1a. The first power supply module 11 can be a built-in battery.

The display module 12 has a built-in touch pad 120 that is electrically connected with the motherboard module 10. Hence, a user can input relevant information or commands to the host unit 1a via the built-in touch pad 120.

The wireless transmission module 13 is received in the host unit 1a and electrically connected with the motherboard module 10. The wireless transmission module 13 is composed of a wireless network module 130 and a wireless data-transmitting module 131. The wireless data-transmitting module 131 can be a Bluetooth module or an IR module. Hence, the user can use the host unit 1a for wireless internet access or transmitting data.

The first I/O interface module 14 is received in the host unit 1a and electrically connected with the motherboard module 10. The first I/O interface module 14 at least includes: a data input/output interface 140, a sound input interface 141, a sound output interface 142, and a power input interface 143. The data input/output interface 140, the sound input interface 141, the sound output interface 142, and the power input interface 143 are electrically connected with the motherboard module 10. The data input/output interface 140 can be a USB connector. Therefore, data from the host unit 1a are transmitted to an external device (not shown) or data from the external device are transmitted to the host unit 1a via the data input/output interface 140. External sound signals are transmitted to the host unit 1a via the sound output interface 142. External power is supplied to the host unit 1a via the power input interface 143 and the first power supply module 11 is to be charged at the same time.

The first electrical connector 15 is exposed outside the host unit 1a and is electrically connected with the motherboard module 10. The first electrical connector 15 is a communication interface in order to communicate the host unit 1a with one-function expansion device.

Moreover, the host unit 1a includes a handwriting pen P and an insertion slot G for receiving the handwriting pen P, and the insertion slot G is formed on a rear face of the host unit 1a (as shown in FIG. 1B).

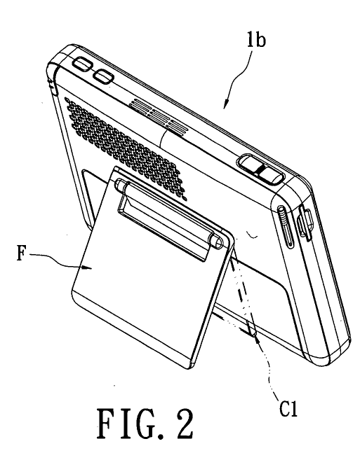

FIG. 2 shows a perspective, schematic view of a host unit according to the second embodiment of the present invention. The difference between the second embodiment and the first embodiment is that: in the second embodiment, a host unit 1b further includes a fixed support F pivoted on a rear face of the host unit 1b. Hence, when a user lifts and opens the fixed support F, the host unit 1b is supported by the fixed support F in order to make the host unit 1b positioned horizontally. When the user wants to get the fixed support F back, the fixed support F can be disposed on the rear face of the host unit 1b in order to make the fixed support F positioned at a close state C1.

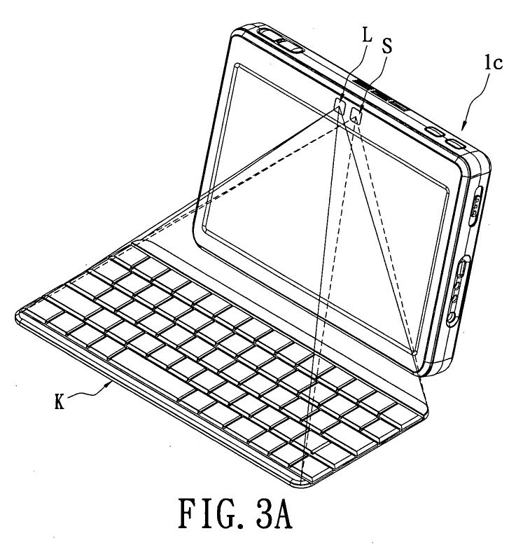

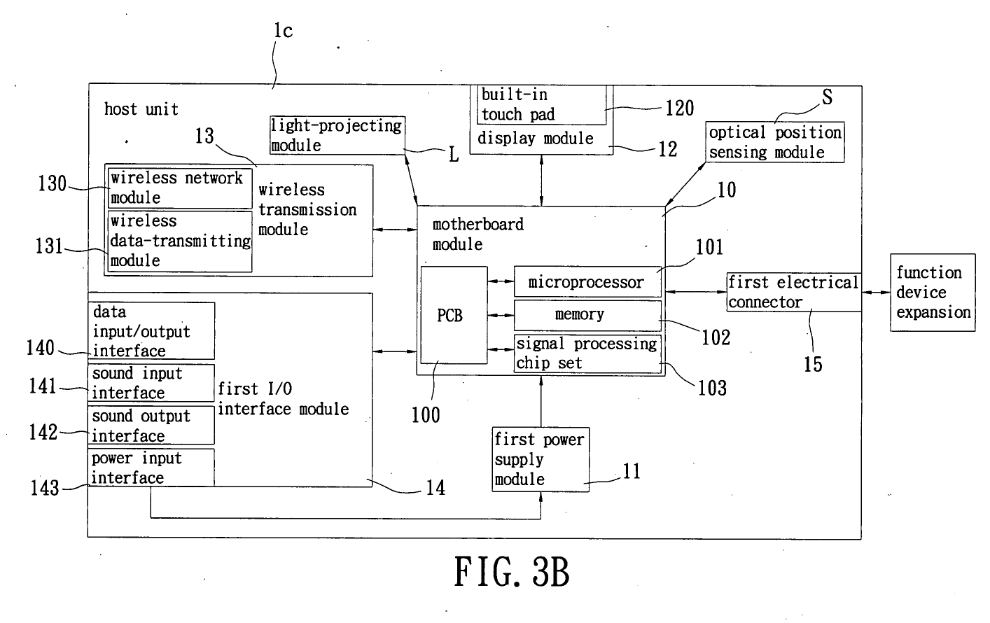

Referring to FIGS. 3A and 3B, FIG. 3A shows a perspective, schematic view of a host unit according to the third embodiment of the present invention, and FIG. 3B shows a function block of a host unit according to the third embodiment of the present invention. The difference between the third embodiment and the second embodiment is that: in the third embodiment, a host unit 1c further includes a light-projecting module L for projecting a fictitious keyboard K and an optical position sensing module S for detecting actions of a user on the fictitious keyboard K. The fictitious keyboard K and the optical position sensing module S are electrically connected with the motherboard module 10.

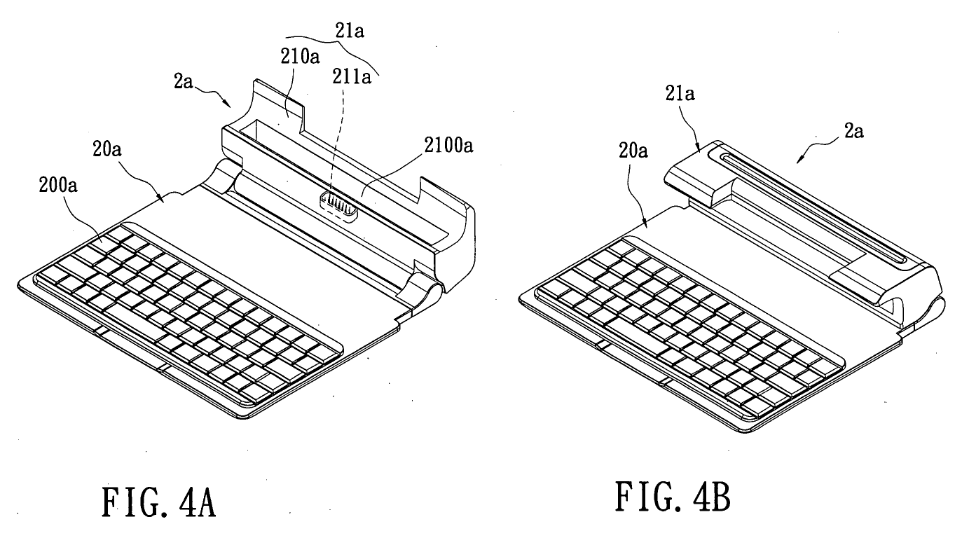

Referring to FIGS. 4A and 4B, FIG. 4A shows a perspective, schematic view of a function expansion unit according to the first embodiment of the present invention, and FIG. 4B shows a perspective, schematic view of a function expansion unit has been folded up according to the first embodiment of the present invention.

Referring to above-mentioned figures, the first embodiment of the present invention provides a function expansion unit 2a that at least includes a keyboard module 20a and a bracket module 21a. The keyboard module 20a is composed of a plurality of key bodies 200a. The bracket module 21a includes a bracket 210a and a second electrical connector 211a disposed on the bracket 210a. In addition, the bracket 210a has a receiving space 2100a for receiving one part of the host unit (1a, 1b or 1c), and the host unit (1a, 1b or 1c) is electrically connected with the function expansion unit 2a by electrically matching the first electrical connector 15 and the second electrical connector 211a.

The bracket module 21a is pivoted on the keyboard module 20a and detachably and electrically connected with the host unit (1a, 1b or 1c). The bracket module 21a shows as open state (as shown in FIG. 4A) or close state (as shown in FIG. 4B) relative to the keyboard module 20a. In other words, the bracket module.21a is selectively rotated toward the keyboard module 20a in order to fold up the bracket module 21a or rotated away from the keyboard module 20a in order to open the bracket module 21a.

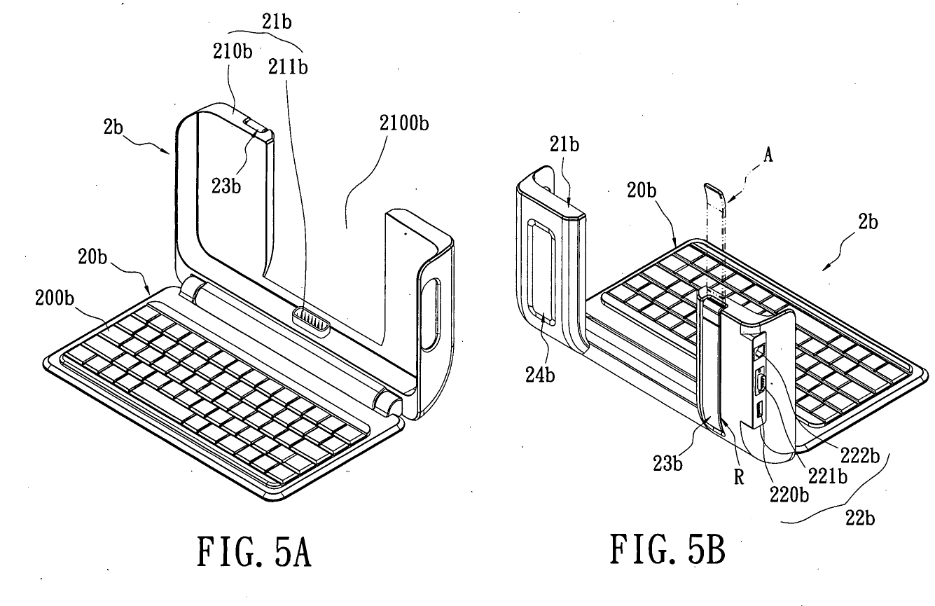

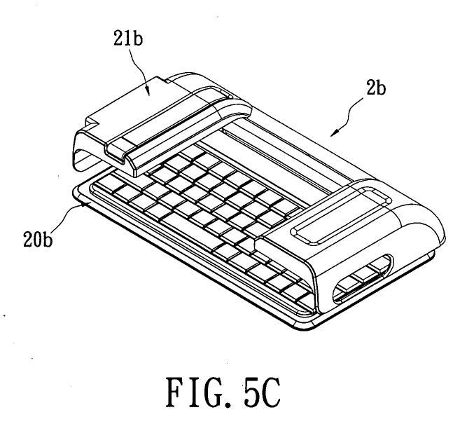

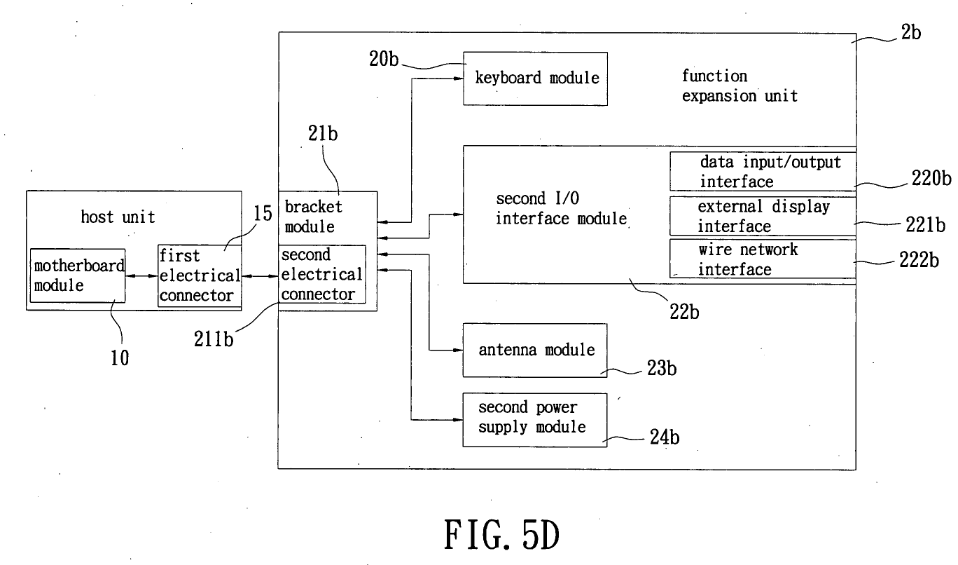

Referring to FIGS. 5A to 5D, FIG. 5A shows one perspective, schematic view of a function expansion unit according to the second embodiment of the present invention, FIG. 5B shows another perspective, schematic view of a function expansion unit according to the second embodiment of the present invention, FIG. 5C shows a perspective, schematic view of a function expansion unit has been folded up according to the second embodiment of the present invention, and FIG. 5D shows a function block of a function expansion unit according to the second embodiment of the present invention. The second embodiment of the present invention provides a function expansion unit 2b that at least includes a keyboard module 20b, a bracket module 21b, a second I/O interface module 22b, an antenna module 23b, and a second power supply module 24b.

The keyboard module 20b is composed of a plurality of key bodies 200b. The bracket module 21b includes a bracket 210b and a second electrical connector 211b disposed on the bracket 210b. In addition; the bracket 210b has a receiving space 2100b for receiving one part of the host unit (1a, 1b or 1c), and the host unit (1a, 1b or 1c) is electrically connected with the function expansion unit 2b by electrically matching the first electrical connector 15 and the second electrical connector 211b. Moreover, the bracket module 21b is pivoted on the keyboard module 20b. The bracket module 21b shows as open state (as shown in FIG. 5A) or close state (as shown in FIG. 5C) relative to the keyboard module 20b.

The second I/O interface module 22b is received in the function expansion unit 2b and electrically connected with the motherboard module 10 of the host unit (1a, 1b or 1c) by electrically matching the first electrical connector 15 and the second electrical connector 211b. Moreover, the second I/O interface module 22b at least includes a data input/output interface 220b, an external display interface 221b, and a wire network interface 222b. The data input/output interface 220b, the external display interface 221b and the wire network interface 222b are electrically connected with the motherboard module 10 of the host unit (1a, 1b or 1c) by electrically matching the first electrical connector 15 and the second electrical connector 211b. In addition, the data input/output interface 220b can be a USB connector, the external display interface 221b can be VGA port, and the wire network interface 222b can be a RJ45 connector.

The antenna module 23b is electrically connected with the motherboard module 10 of the host unit (1a, 1b or 1c) by electrically matching the first electrical connector 15 and the second electrical connector 211b. In addition, the antenna module 23b is pivoted on the bracket module 21b. Hence, when the user wants to use the antenna module 23b or enhance the receiving function of the antenna module 23b, the antenna module 23b can be opened as an open state A; when the user wants to receive the antenna module 23b, the antenna module 23b can be received in a receiving groove R formed on a rear face of the bracket 210b.

The second power supply module 24b is received in the bracket 210b and electrically connected with the motherboard module 10 of the host unit (1a, 1b or 1c) by electrically matching the first electrical connector 15 and the second electrical connector 211b in order to supply power to the host unit (1a, 1b or 1c). In addition, the second power supply module 24b can be a built-in battery.

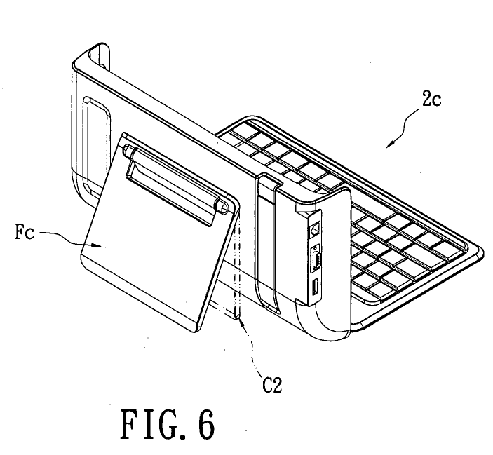

FIG. 6 shows a perspective, schematic view of a function expansion unit according to the third embodiment of the present invention. The difference between the third embodiment and the second embodiment is that: in the third embodiment, a function expansion unit 1c further includes a fixed support Fc pivoted on a rear face of the host unit 1c. Hence, when a user lifts and opens the fixed support Fc, the host unit 1c is supported by the fixed support Fc in order to make the host unit 1c positioned horizontally. When the user wants to get the fixed support Fc back, the fixed support Fc can be disposed on the rear face of the host unit 1c in order to make the fixed support Fc positioned at a close state C2.

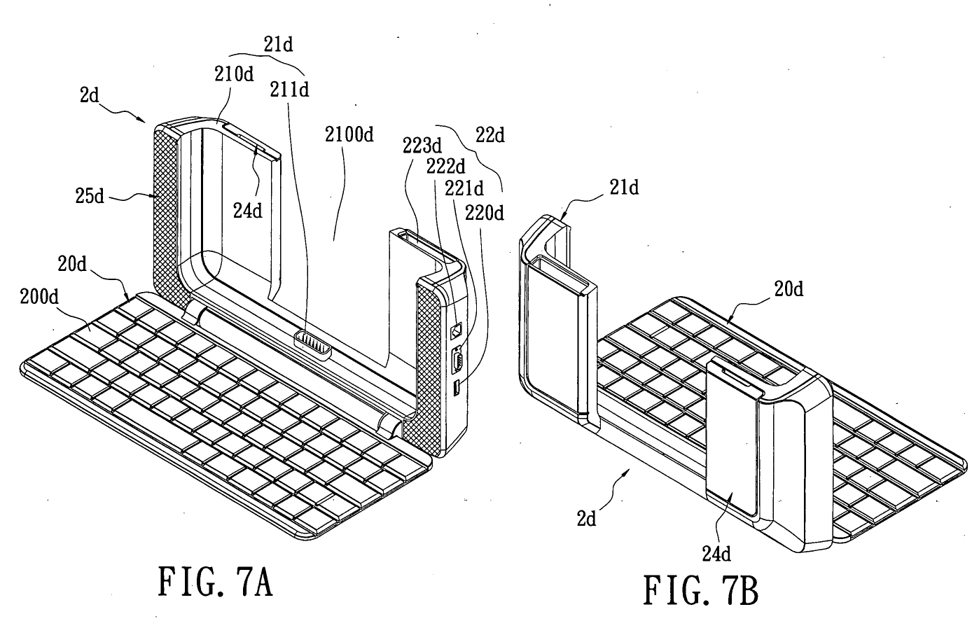

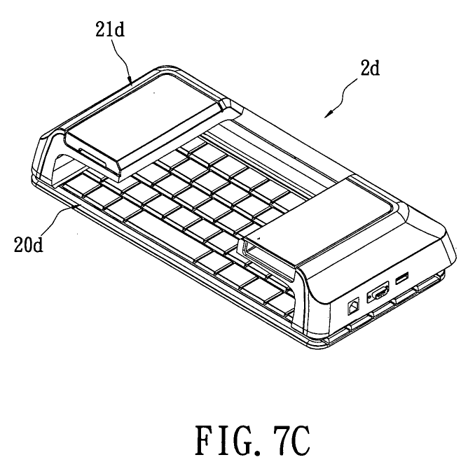

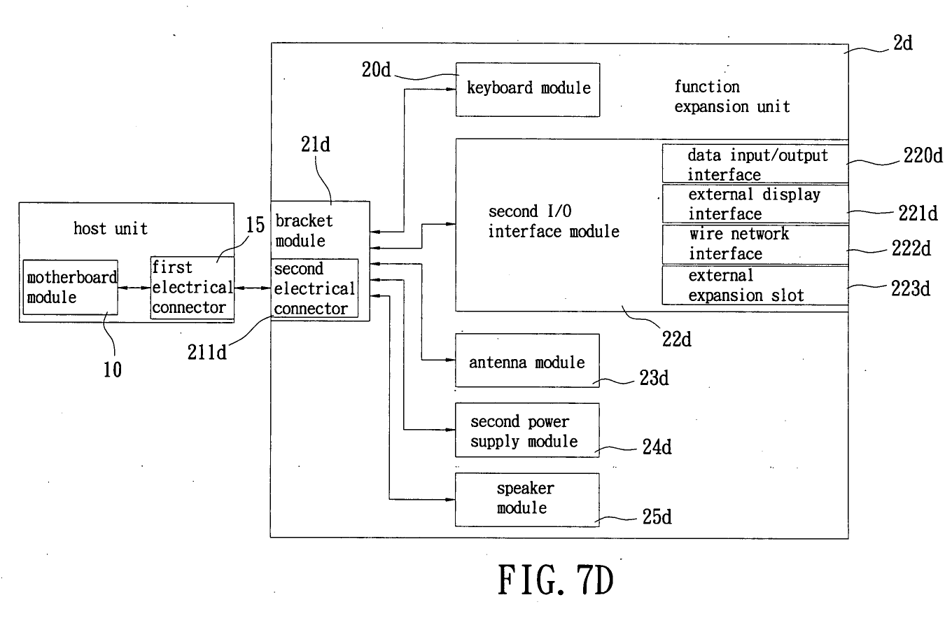

Referring to FIGS. 7A to 7D, FIG. 7A shows one perspective, schematic view of a function expansion unit according to the fourth embodiment of the present invention, FIG. 7B shows another perspective, schematic view of a function expansion unit according to the fourth embodiment of the present invention, FIG. 7C shows a perspective, schematic view of a function expansion unit has been folded up according to the fourth embodiment of the present invention, and FIG. 7D shows a function block of a function expansion unit according to the fourth embodiment of the present invention. The fourth embodiment of the present invention provides a function expansion unit 2d that at least includes a keyboard module 20d, a bracket module 21d, a second I/O interface module 22d, an antenna module 23d, a second power supply module 24d, and a speaker module 25d.

The keyboard module 20d is composed of a plurality of key bodies 200d. The bracket module 21d includes a bracket 210d and a second electrical connector 211d disposed on the bracket 210d. In addition, the bracket 210d has a receiving space 2100d for receiving one part of the host unit (1a, 1b or 1c), and the host unit (1a, 1b or 1c) is electrically connected with the function expansion unit 2d by electrically matching the first electrical connector 15 and the second electrical connector 211d. Moreover, the bracket module 21d is pivoted on the keyboard module 20d. The bracket module 21d shows as open state (as shown in FIG. 7A) or close state (as shown in FIG. 7C) relative to the keyboard module 20d.

The second I/O interface module 22d is received in the function expansion unit 2d and electrically connected with the motherboard module 10 of the host unit (1a, 1b or 1c) by electrically matching the first electrical connector 15 and the second electrical connector 211d. Moreover, the second I/O interface module 22d at least includes a data input/output interface 220d, an external display interface 221d, a wire network interface 222d, and an external expansion slot 223d. The data input/output interface 220d, the external display interface 221d, the wire network interface 222d and the external expansion slot 223d are electrically connected with the motherboard module 10 of the host unit (1a, 1b or 1c) by electrically matching the first electrical connector 15 and the second electrical connector 211d. In addition, the data input/output interface 220d can be a USB connector, the external display interface 221d can be VGA port, the wire network interface 222d can be a RJ45 connector, and the external expansion slot 223d can be a PCI express slot.

The antenna module 23d is received in the function expansion unit 2d and electrically connected with the motherboard module 10 of the host unit (1a, 1b or 1c) by electrically matching the first electrical connector 15 and the second electrical connector 211d. In addition, the antenna module 23d is a built-in antenna embedded in the bracket 210d of the bracket module 21d.

The second power supply module 24d is received in the bracket 210d and electrically connected with the motherboard module 10 of the host unit (1a, 1b or 1c) by electrically matching the first electrical connector 15 and the second electrical connector 211d in order to supply power to the host unit (1a, 1b or 1c). In addition, the antenna module 24d can be a built-in battery. The speaker module 25d is exposed and disposed on two sides of the bracket 210d, and the speaker module 25d is electrically connected with the motherboard module 10 of the host unit (1a, 1b or 1c) by electrically matching the first electrical connector 15 and the second electrical connector 211d. Hence, the present invention can directly output sound signals by the speaker module 25d.

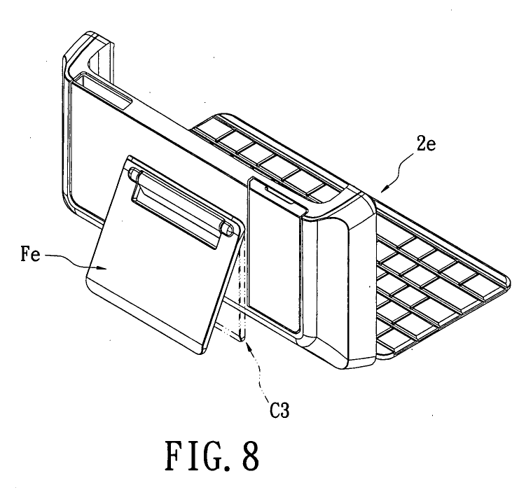

FIG. 8 shows a perspective, schematic view of a function expansion unit according to the fifth embodiment of the present invention. The difference between the fifth embodiment and the fourth embodiment is that: in the fifth embodiment, a function expansion unit 1b further includes a fixed support Fe pivoted on a rear face of the function expansion unit 2e. Hence, when a user lifts and opens the fixed support Fe, the function expansion unit 2e is supported by the fixed support Fe in order to make the function expansion unit 2e positioned horizontally. When the user wants to get the fixed support Fe back, the fixed support Fe can be disposed on the rear face of the function expansion unit 2e in order to make the fixed support Fe positioned at a close state C3.

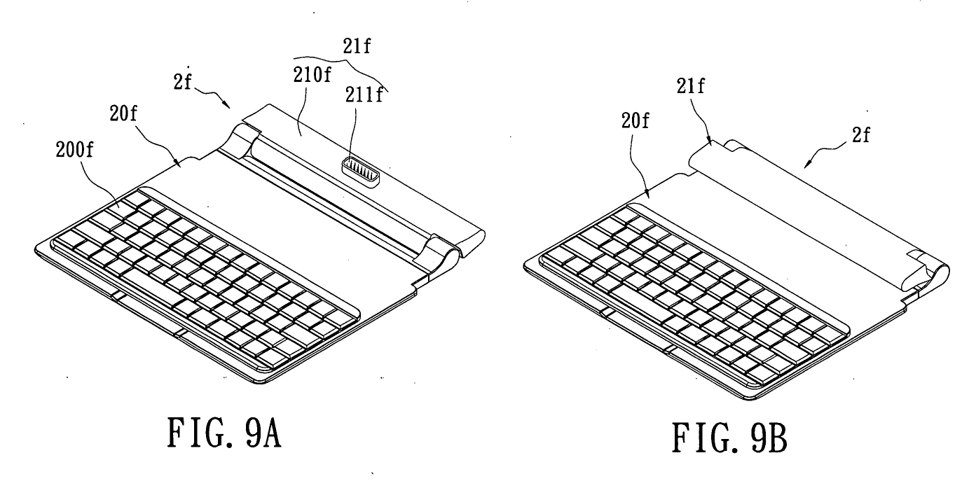

Referring to FIGS. 9A and 9B, FIG. 9A shows a perspective, schematic view of a function expansion unit according to the sixth embodiment of the present invention, and FIG. 9B shows a perspective, schematic view of a function expansion unit has been folded up according to the sixth embodiment of the present invention. The sixth embodiment of the present invention provides a function expansion unit 2f that at least includes a keyboard module 20f and a bracket module 21f. The keyboard module 20f is composed of a plurality of key bodies 200f. The bracket module 21f includes a bracket 210f and a second electrical connector 211f disposed on the bracket 210f. In addition, the host unit (1a, 1b or 1c) is electrically connected with the function expansion unit 2f by electrically matching the first electrical connector 15 and the second electrical connector 211f.

The bracket module 21f is pivoted on the keyboard module 20f. The bracket module 21f shows as open state (as shown in FIG. 9A) or close state (as shown in FIG. 9B) relative to the keyboard module 20f. In other words, the bracket module 21f is selectively rotated toward the keyboard module 20f in order to fold up the bracket module 21f or rotated away from the keyboard module 20f in order to open the bracket module 21f.

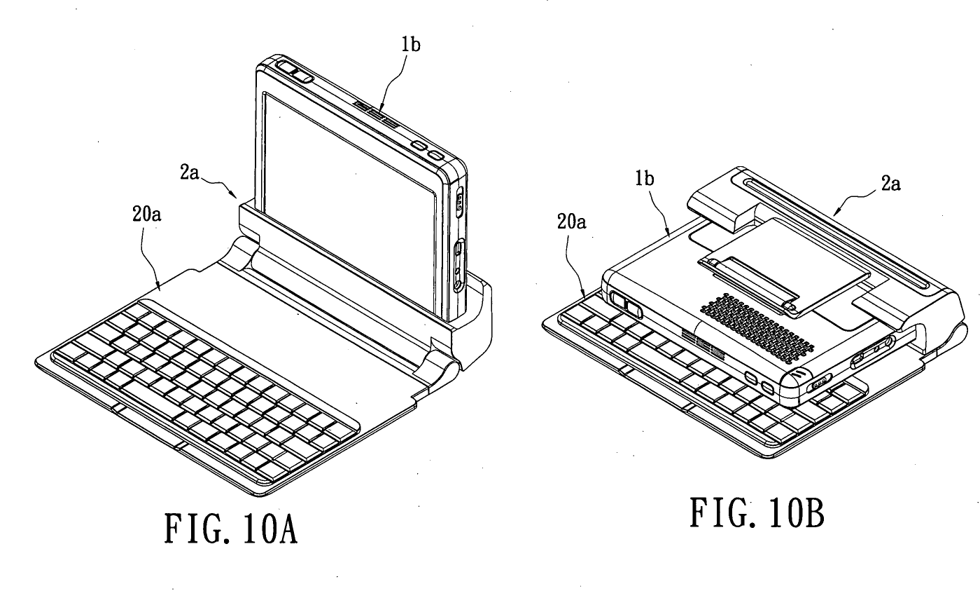

Referring to FIGS. 10A and 10B, FIG. 10A shows a perspective, schematic view of a host unit of the second embodiment electrically connected with a function expansion unit of the first embodiment, and FIG. 10B shows a perspective, schematic view of a host unit of the second embodiment electrically connected with and folded toward a function expansion unit of the first embodiment. The user not only can use the host unit 1b independently (as shown in FIG. 2), but it is convenient for the user to key in data into the host unit 1b by electrically matching the host unit 1b and the keyboard module 20a of the function expansion unit 2a (as shown in FIG. 4A). Hence, the user can selectively use the host unit 1b independently or use the combination of the host unit 1b and the function expansion unit 2a in order to key in data quickly.

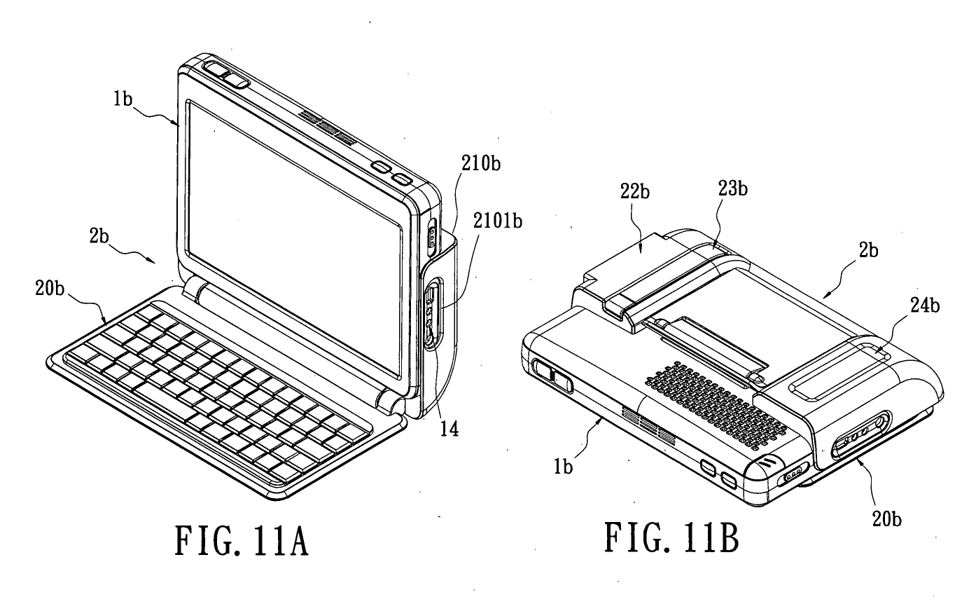

Referring to FIGS. 11A and 11B, FIG. 11A shows a perspective, schematic view of a host unit of the second embodiment electrically connected with a function expansion unit of the second embodiment, and FIG. 11B shows a perspective, schematic view of a host unit of the second embodiment electrically connected with and folded toward a function expansion unit of the second embodiment. The user not only can use the host unit 1b independently (as shown in FIG. 2), but it is convenient for the user to key in data into the host unit 1b and expand computer functions that the user needs by matching the host unit 1b, the keyboard module 20b, the second I/O interface module 22b, the antenna module 23b and the second power supply module 24b (as shown in FIG. 5A). In addition, the bracket 210b has an opening 2101b for exposing the first I/O interface module 14. Hence, the user can selectively use the host unit 1b independently or use the combination of the host unit 1b and the function expansion unit 2a in order to key in data quickly and expand computer functions that the user needs.

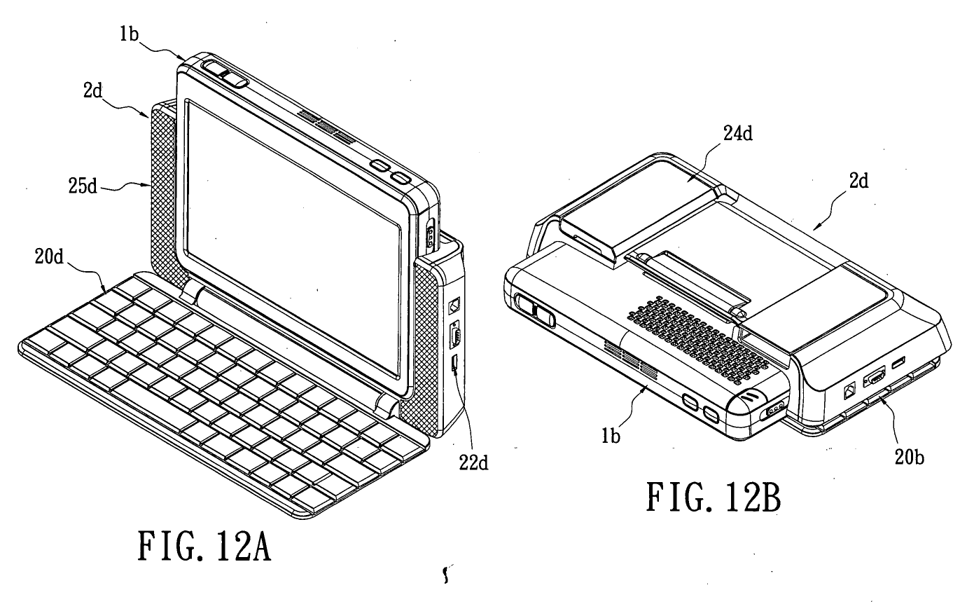

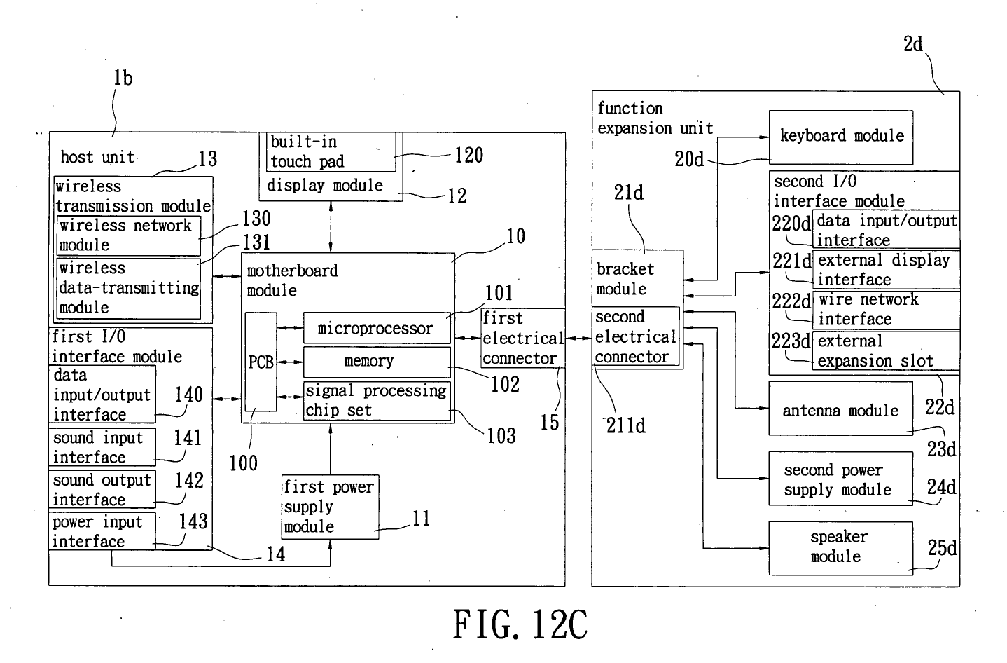

Referring to FIGS. 12A and 12C, FIG. 12A shows a perspective, schematic view of a host unit of the second embodiment electrically connected with a function expansion unit of the fourth embodiment, FIG. 12B shows a perspective, schematic view of a host unit of the second embodiment electrically connected with and folded toward a function expansion unit of the fourth embodiment, and FIG. 12C shows a function block of a host unit of the second embodiment electrically connected with a function expansion unit of the fourth embodiment. The user not only can use the host unit 1b independently (as shown in FIG. 2), but it is convenient for the user to key in data into the host unit 1b and expand computer functions that the user needs by matching the host unit 1b, the keyboard module 20d, the second I/O interface module 22d, the antenna module 23d, the second power supply module 24d and the speaker module 25d (as shown in FIG. 7A). Hence, the user can selectively use the host unit 1b independently or use the combination of the host unit 1b and the function expansion unit 2d in order to key in data quickly and expand computer functions that the user needs.

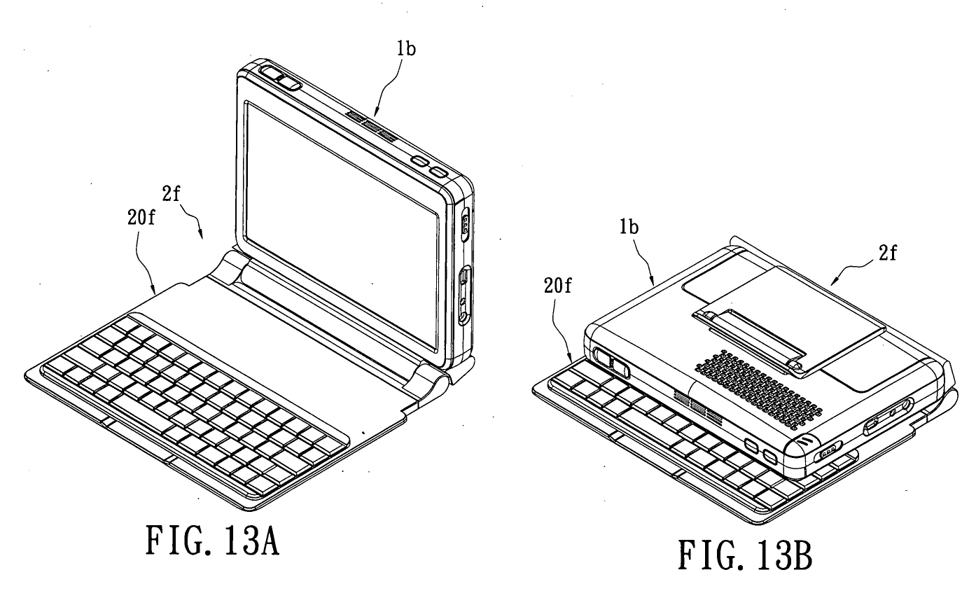

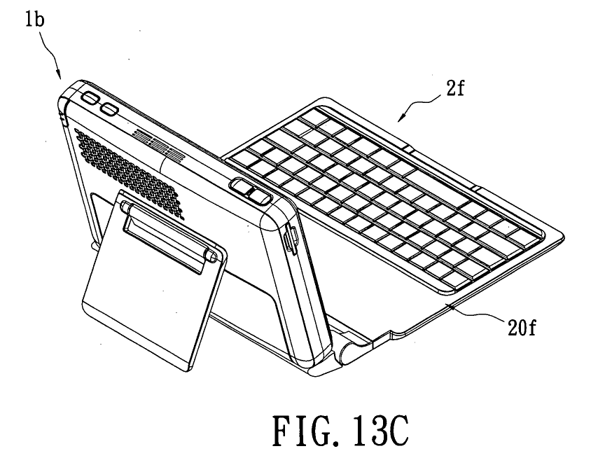

Referring to FIGS. 13A and 13C, FIG. 13A shows one perspective, schematic view of a host unit of the second embodiment electrically connected with a function expansion unit of the sixth embodiment, FIG. 13B shows a perspective, schematic view of a host unit of the second embodiment electrically connected with and folded toward a function expansion unit of the sixth embodiment, and FIG. 13C shows another perspective, schematic view of a host unit of the second embodiment electrically connected with a function expansion unit of the sixth embodiment. The user not only can use the host unit 1b independently (as shown in FIG. 2), but it is convenient for the user to key in data into the host unit 1b by matching the host unit 1b and the keyboard module 20f of the function expansion unit 2f (as shown in FIG. 9A). Hence, the user can selectively use the host unit 1b independently or use the combination of the host unit 1b and the function expansion unit 2f in order to key in data quickly.

In conclusion, the portable computer system is divided into two parts that includes an independent host unit (1a, 1b or 1c) and a function expansion unit (2a, 2b, 2c, 2d, 2e or 2f). The key feature of the present invention is that: some base computer functions such as a display with a touch pad, a battery, a wireless network and some base I/O interfaces etc. are disposed in the host unit, some secondary or expansion computer functions such as a keyboard, an antenna, wire connector and other expansion I/O interfaces are disposed in the function expansion unit. On the other hand, the function expansion unit can be a custom-made product according to user's requirements, such as if the function expansion unit needs to own an strong multimedia function and a strong key-in function, a horn and a large keyboard need to be disposed in the function expansion unit.

Therefore, on one hand the size and the weight of the host unit can be decreased, on the other hand the user can use complete computer function by electrically matching the host unit and the function expansion unit. Hence, some expansion devices such as keyboard can be disposed in the function expansion unit in order to operate the portable computer system easily for the user. Moreover, on one hand different consumers can establish own standards according to selective function expansion unit, on the other hand the consumer can only select the host unit with some base computer functions due to low cost or select the combination of the host unit and the function expansion unit with extra computer functions due to allowable cost.

Although the present invention has been described with reference to the preferred best molds thereof, it will be understood that the invention is not limited to the details thereof. Various substitutions and modifications have been - suggested in the foregoing description, and others will occur to those of ordinary skill in the art. Therefore, all such substitutions and modifications are intended to be embraced within the scope of the invention as defined in the appended claims.

What is claimed is:

1. A portable computer system for expanding usage function comprising an independent host unit and a function expansion unit, wherein the function expansion unit comprises:
a keyboard module electrically connected with the host unit; and
a bracket module pivoted on the keyboard module and detachably and electrically connected with the host unit.

2. The portable computer system as claimed in claim 1, wherein the host unit includes:
a motherboard module;
a first power supply module electrically connected with the motherboard module;
a display module with a built-in touch pad electrically connected with the motherboard module;
a wireless transmission module electrically connected with the motherboard module; and
a first I/O interface module electrically connected with the motherboard module.

3. The portable computer system as claimed in claim 2, wherein the wireless transmission module is composed of a wireless network module and a wireless data-transmitting module.

4. The portable computer system as claimed in claim 2, wherein the first I/O interface module includes: a data input/output interface, a sound input interface, a sound output interface, a power input interface, and the data input/output interface, the sound input interface, the sound output interface and the power input interface are electrically connected with the motherboard module.

5. The portable computer system as claimed in claim 1, wherein the host unit includes a handwriting pen and an insertion slot for receiving the handwriting pen, and the insertion slot is formed on a rear face of the host unit.

6. The portable computer system as claimed in claim 1, wherein the host unit includes a fixed support pivoted on a rear face thereof.

7. The portable computer system as claimed in claim 1, wherein the host unit includes a light-projecting module for projecting a fictitious keyboard and an optical position sensing module for detecting actions of a user on the fictitious keyboard, and the fictitious keyboard and the optical position sensing module are electrically connected with the motherboard module.

8. The portable computer system as claimed in claim 1, wherein the host unit includes a first electrical connector electrically connected with the motherboard module.

9. The portable computer system as claimed in claim 8, wherein the bracket module includes a bracket and a second electrical connector disposed on the bracket, the bracket has a receiving space for receiving one part of the host unit, and the host unit is electrically connected with the function expansion unit by electrically matching the first electrical connector and the second electrical connector.

10. The portable computer system as claimed in claim 2, wherein the bracket module has an opening for exposing the first I/O interface module.

11. The portable computer system as claimed in claim 1, wherein the keyboard module is composed of a plurality of key bodies.

12. The portable computer system as claimed in claim 1, wherein the bracket module is selectively rotated toward the keyboard module in order to fold up the bracket module or rotated away from the keyboard module in order to open the bracket module.

13. The portable computer system as claimed in claim 1, wherein the function expansion unit has a fixed support pivoted on a rear face of the bracket module.

14. The portable computer system as claimed in claim 1, wherein the function expansion unit has a second I/O interface module electrically connected with the host unit.

15. The portable computer system as claimed in claim 14, wherein the second I/O interface module includes an external expansion slot, a data input/output interface, an external display interface, and a wire network interface, and the external expansion slot, the data input/output interface, the external display interface and the wire network interface are electrically connected with the motherboard module of the host unit.

16. The portable computer system as claimed in claim 1, wherein the function expansion unit has an antenna module electrically connected with the host unit.

17. The portable computer system as claimed in claim 16, wherein the antenna module is pivoted on the bracket module.

18. The portable computer system as claimed in claim 16, wherein the antenna module is a built-in antenna embedded in the bracket module.

19. The portable computer system as claimed in claim 1, wherein the function expansion unit has a second power supply module electrically connected with the host unit

20. The portable computer system as claimed in claim 1, wherein the function expansion unit has a speaker module electrically connected with the host unit.
